(19) United States
(12) Patent Application Publication
(10) Pub. No.: US 2024/0156299 A1
(43) Pub. Date: May 16, 2024

(54) HOT DRINK PREPARATION DEVICE WITH HOT WATER BOILER

(71) Applicant: Franke Kaffeemaschinen AG, Aarburg (CH)

(72) Inventors: David Oggier, Oberkirch (CH); Serge WÄCHTER, Basel (CH)

(73) Assignee: Franke Kaffeemaschinen AG, Aarburg (CH)

(21) Appl. No.: 18/509,454

(22) Filed: Nov. 15, 2023

(30) Foreign Application Priority Data
Nov. 15, 2022 (EP) 22207613.5

(51) Int. Cl. A47J 31/56; A47J 31/40; A47J 31/44; A47J 31/46

(52) U.S. Cl. CPC A47J 31/56; A47J 31/402; A47J 31/4407; A47J 31/461

(57) ABSTRACT

In a hot beverage preparation device, in particular a coffee machine, having a hot water boiler for heating and storing hot water or hot steam for preparing hot beverages, the hot water boiler has a cold water inlet, a storage vessel having a heater and a hot water and/or steam outlet. The storage vessel is at least partially provided or surrounded with a vacuum insulation. The heat loss of the hot water boiler can be significantly reduced by the vacuum insulation.

### CROSS-REFERENCE TO RELATED APPLICATIONS

This application claims priority to European Patent Application No. EP 22207613.5, filed Nov. 15, 2022, which is incorporated herein by reference as if fully set forth.

### TECHNICAL FIELD

The present invention relates to a hot beverage preparation device, in particular a coffee machine, having a hot water boiler for heating and storing hot water or hot steam for preparing hot beverages, wherein the hot water boiler has a cold water intake, a storage vessel having a heater, and a hot water or steam outlet.

### BACKGROUND

In automatic coffee machines, boilers, which store hot water in the temperature range of less than 100°, typically around approximately 90° C., are often used to store hot water required for beverage preparation. Even separate boilers for hot water and steam are often provided. The waste heat of the boilers necessarily arising during the hot water production has to be dissipated so that the device does not become excessively hot in the interior. Excessively high temperatures in the interior of an automatic coffee machine can result in the temporary failure of components, long-term defects due to premature aging, and varying product quality. In particular in devices having a very compact structure, thermal problems can occur if sufficient space is not present to dissipate the waste heat arising on the device outside. Automatic coffee machines often have to be actively cooled by means of fans in order to dissipate the waste heat during the hot water preparation.

### SUMMARY

It is therefore an object of the present invention to specify a hot beverage preparation device which is improved with regard to the temperature management and enables a very compact structure.

The object is achieved by a hot beverage preparation device having one or more of the features disclosed herein. Advantageous embodiments can be found below and in the claims.

In a hot beverage preparation device of the type mentioned at the outset, it is provided according to the invention that the storage vessel is at least partially provided or surrounded with a vacuum insulation.

The heat loss of the hot water boiler can be significantly reduced in comparison to normally insulated boilers by the use of a vacuum insulation. The low waste heat has a positive effect on the quality, storability, and the grinding behavior of fresh coffee beans, which are typically stored uppermost on the device and therefore are particularly subjected to the rising waste heat. Active cooling or ventilation of the device can be omitted or the cooling capacity can at least be significantly reduced due to the reduced waste heat. Due to the lower waste heat of the vacuum-insulated hot water boiler, the energy consumption of the device is reduced and therefore the energy efficiency is improved and operating costs and CO₂ emissions are reduced.

In the simplest case, the outer wall of the storage vessel of the boiler can simply be embodied as double-walled at least in some areas, so that the double-walled area of the outer wall encloses an evacuated space. The boiler is thus embodied compactly and has little waste heat.

Alternatively, the storage vessel can be inserted into an external envelope which is double-walled at least in some areas, the double-walled area of which encloses an evacuated space, for the vacuum insulation. A conventional boiler can thus be used which can be removed from the vacuum-insulating external envelope and replaced for repair or exchange in case of a defect.

In both cases, it is possible to provide the double-walled storage vessel or the double-walled external envelope with a non-vacuum-insulated cover, through which electrical and/or hydraulic connections of the boiler are led. Feedthroughs can thus be implemented in a simple manner without having to penetrate the vacuum envelope complexly. The non-vacuum-insulated cover can be provided, for example, in a conventional manner with a thermal insulation made of insulating material.

A boiler for preparing and storing steam, which in normal operation contains a steam volume under pressure and a hot water volume which has not yet evaporated under the prevailing temperature and pressure conditions, is also viewed as a hot water boiler in the scope of the invention. A hot water boiler in the scope of the invention can also be used for simultaneously providing hot water and steam and can be provided with both a hot water outlet and a steam outlet.

In one preferred refinement of the invention, it is provided that the hot water is stored at a temperature of greater than 100° C. and is brought to a preparation temperature of less than 100° C. by adding cold water during the beverage preparation. For this purpose, the storage vessel of the hot water boiler is embodied as a pressure vessel, in which the hot water is stored in operation at a temperature of greater than 100° C. and the hot water outlet is connected to a metering valve for metered cold water admixture, in order to admix cold water to the hot water during the dispensing so that mixed water having a temperature of less than 100° C. is dispensed for the beverage preparation.

The storage of hot water under pressure at greater than 100° C. and adding cold water upon the removal are fundamentally independent of the use of a vacuum-insulated boiler and represent an independent inventive contribution. Although the use of a vacuum-insulated boiler is accompanied by special advantages in this case due to the higher storage temperature, in principle a normal, conventionally insulated hot water boiler can also be used.

Due to the cold water admixture, the amount of the hot water available for beverage preparation is increased or the boiler can be constructed more compactly with an equal amount of hot water available for the beverage preparation. The waste heat of conventional hot water boilers increases significantly due to the higher storage temperature. However, the vacuum insulation according to the invention substantially reduces the waste heat, so that in spite of higher storage temperature, the device can be compactly constructed and the permissible operating temperature in the interior of the device is not exceeded.

The storage temperature can be selected for this purpose above 110° C., preferably in a range from 110° C. to 180° C., more preferably in the range from 120° C. to 140° C.

Furthermore, it is preferred for the cold water admixture to take place in a regulated manner in that the metering valve for the cold water admixture is embodied as a controllable valve, in particular a proportional valve, and the beverage preparation device has a temperature sensor for determining the mixed water temperature and a control device for regulating the mixed water temperature by activating the metering valve. The dispensing temperature of the hot water can thus be regulated to different values depending on the desired beverage. For example, less cold water can be admixed for espresso coffee and more cold water can be admixed for tea water for preparing green tea.

A static mixer, in particular a helical mixer for mixing the cold and hot water flows, can be arranged between the metering valve and the temperature sensor. This ensures rapid and thorough mixing of the water flows. The mixed water temperature resulting after the mixing as a control variable can thus be measured directly after it. This enables a particularly compact structure.

The heater of the boiler can expediently be designed as a heating coil arranged inside the storage vessel. This results in a particularly compact structure of the boiler. In particular, it can be provided that the heater is designed as a coiled tubular heater in that the heating coil extends within a coiled heating tube, which is preferably filled with magnesium oxide powder for the electrical insulation of the heating coil.

It is within the scope of the invention to provide not only one vacuum-insulated hot water boiler, but rather multiple hot water boilers of which, for example, one is provided for steam production and a further one for hot water production and both are each provided or surrounded with a vacuum insulation. The use of more than two hot water boilers, for example to enable a parallel acquisition of two beverages, can also be provided.

### BRIEF DESCRIPTION OF THE DRAWINGS

Further advantages and embodiments of the invention result on the basis of the following description of exemplary embodiments on the basis of the figures.

In the figures:

FIG. 1 shows a first exemplary embodiment of a vacuum-insulated hot water boiler,

FIG. 2 shows an exemplary embodiment of a hot water boiler inserted into a vacuum-insulated external envelope,

FIG. 3 shows a water flow diagram of a hot beverage preparation device having two vacuum-insulated hot water boilers, one for providing hot water and one for providing steam,

FIG. 4 shows the time curve of the hot water temperature within the hot water boiler in a diagram which illustrates the detection of the cooling curve to assess the quality of the vacuum insulation, and

FIG. 5 shows a water flow diagram of a hot beverage preparation device in a further exemplary embodiment, in which a static mixer is additionally provided for mixing cold water supplied via a mixing valve with hot water taken from the hot water boiler.

### DETAILED DESCRIPTION

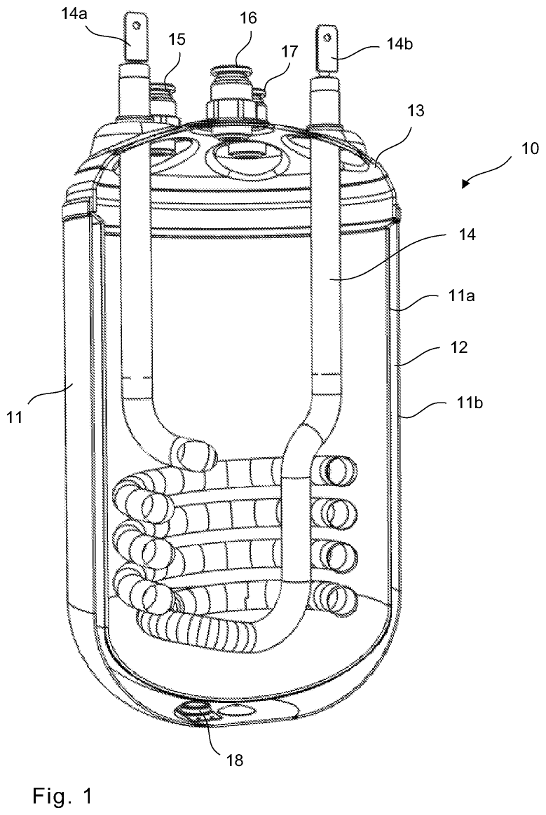

A hot water boiler 10, which is used according to the invention in a hot beverage preparation device, such as a coffee machine, is shown in a section in FIG. 1. The hot water boiler 10 comprises a storage vessel 11, which is embodied as double-walled in the lower area and has an internal outer wall 11a and an external outer wall 11b. A gap space 12 is located therebetween, which is evacuated so that the outer wall 11a, 11b has a vacuum insulation. In the upper area, the hot water boiler 10 is provided with a cover 13 embodied as only single-walled, through which electrical and hydraulic feedthroughs extend. A coiled tubular heating element 14 is located in the interior of the storage vessel 10. This heating element has two electrical connections 14a, 14b, which are led outward through corresponding feedthroughs in the cover 13. In addition, the hot water boiler has multiple free feedthroughs 15, 16, 17. Feed lines and discharge lines, as well as measuring devices such as a manometer or a thermometer, can be connected through these feedthroughs. An evacuation valve 18, via which the gap space 12 between the internal and the external outer wall 11a, 11b was evacuated, is located in the lower area.

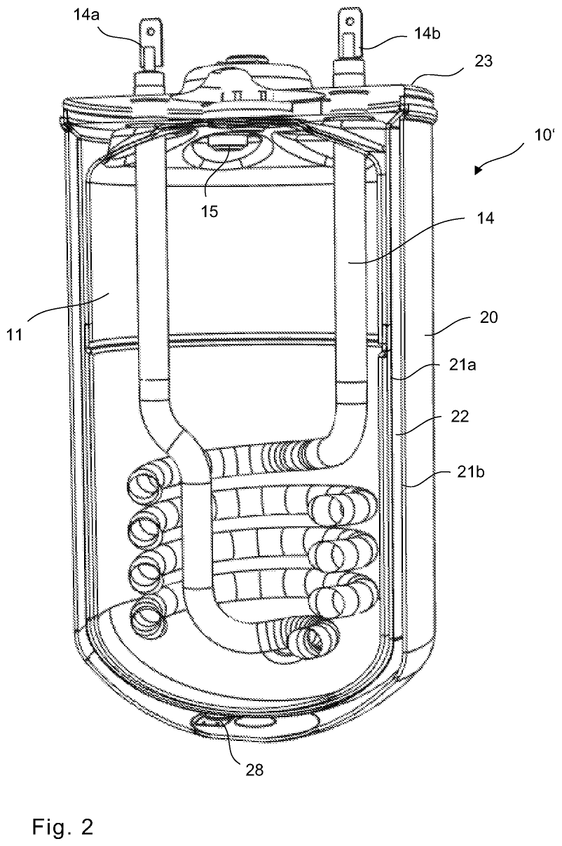

FIG. 2 likewise shows a view in partial section of a second exemplary embodiment for a vacuum-insulated hot water boiler 10. The hot water boiler 10 comprises in this case a storage vessel 11′, which is embodied in a conventional manner as single-walled. A coiled tubular heating element 14 is arranged in the storage vessel, which has two electrical connections 14a, 14b, which are led outward through a feedthrough arranged in the upper area of the storage vessel 11′. Further feedthroughs, of which only one feedthrough 15 is visible in FIG. 2, are used for connecting feed and discharge lines, and possibly measuring instruments.

The storage vessel 11′ is located inside a vacuum-insulated external envelope 20, the lower area of which is embodied as double-walled having an internal outer wall 21a and an external outer wall 21b. A gap space 22, which was evacuated via an evacuation valve 28, is located therebetween. The external envelope 20 is closed in the upper area with the aid of a non-vacuum-insulated cover 23, through which the electrical and hydraulic feedthroughs extend. The cover 23 can be insulated in a conventional manner using insulating material (such as needle felt made of synthetic fibers, silicone foam, glass wool, or the like). The cover 23 can be opened for the installation or removal of the water boiler 10 or for its repair, so that the hot water boiler 10 can be maintained and replaced without the vacuum-insulated external envelope 20.

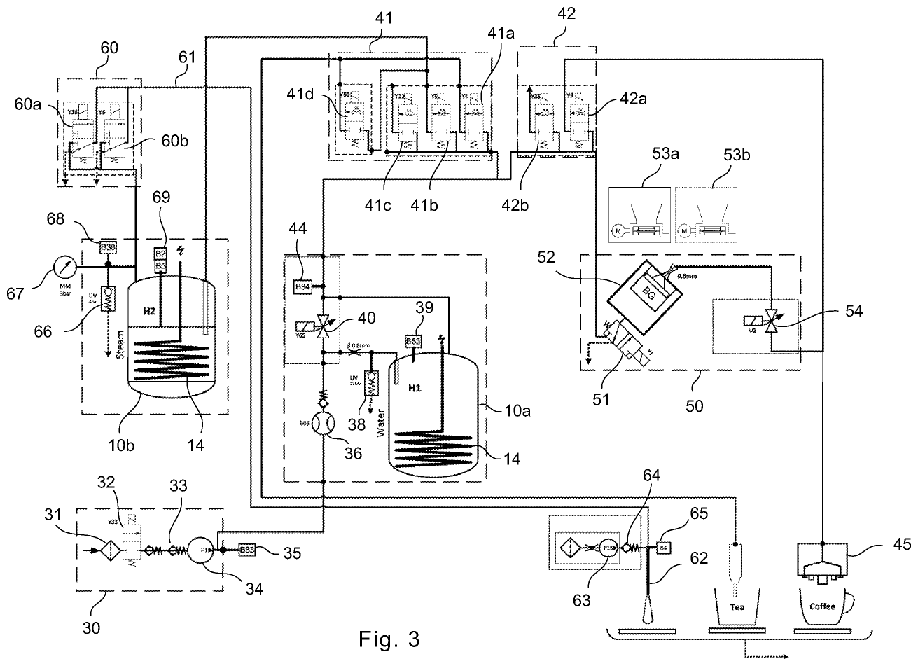

A so-called water flow diagram of a coffee machine according to the invention having two hot water boilers 10a, 10b is shown in FIG. 3, which are both provided or surrounded in a manner according to the invention with a vacuum insulation, as explained above. The hot water boiler 10a is used for preparing and storing hot water for beverage preparation and the hot water boiler 10b is used for preparing and storing steam for foaming milk and contains a water volume and a steam volume, which are in thermal equilibrium.

An assembly 30 having a water filter 31, a shutoff valve 32, two check valves 33 connected in succession, a water pump 34, and a temperature sensor 35 is located at a water intake, which is connected on the inlet side to the connection of a water supply or a water container. Cold water reaches the feed of the boiler 10a from the water pump 34 via a flow meter 36 and a further check valve 37. The water is heated to a storage temperature of 120° C. to 140° C. in the hot water boiler 10a. The temperature in the hot water boiler 10a can be determined via a temperature sensor 39 and can be regulated by activating the heater 14 of the hot water boiler 10a. A pressure relief valve 38 at the feed of the boiler conducts water in case of an overpressure out of the hot water boiler 10a to an outlet. The hot water outlet of the boiler 10a leads to two valve blocks 41, 42. A proportional valve 40, using which cold water can be admixed to hot water from the hot water boiler 10a, is located between intake and outlet of the hot water boiler 10a. The water temperature of the mixed water can be measured via a temperature sensor 44 and can be set by appropriate activation of the proportional valve 40.

Mixing of the hot water and the cold water supplied via the proportional valve 40 can take place in the hose line after the combination of cold and hot water. To achieve the fastest possible mixing of the two water flows, a static mixer 43, such as a helical mixer, can additionally be arranged, which thoroughly mixes the two water flows. This is schematically shown in FIG. 5. A helical mixer is a static mixer in which multiple 180° helices, arranged in succession and each offset by 90° from one another, are arranged in a tubular housing. In addition, the successive helices each have an opposite rotational direction. Each helix divides the flow of the liquid flowing through into two partial flows. These are in turn divided into two partial flows at each transition to the respective following helix and are each brought together with partial flows from the preceding helix. In this way, thorough mixing of the liquid flow takes place.

The hot water outlet of the hot water boiler 10a is connected to the two valve blocks 41, 42. Hot water for tea preparation can be dispensed via the valve 41a and the valve 41b can fill the hot water boiler 10b for the steam preparation. The valve 41c is not occupied in the exemplary embodiment and is available for further optional functions. The inlet of the valve 41d is connected to the outlet of the valve 41b and also leads to the hot water outlet, so that hot water and steam can be dispensed simultaneously. Hot water can be dispensed via the valve 42a at the beverage outlet head 45, which can be used, for example, for instant beverages or for admixing to coffee beverages. In addition, the outlet line from the brewing assembly 52 to the outlet head 45 can be flushed via the valve 42a. The valve 42b is not occupied in the exemplary embodiment and can be used, for example, for the option “instant beverages”. Moreover, a line leads to the brewing valve 51 in the brewing unit 50 from the hot water outlet of the hot water boiler 10a. The brewing unit 50 comprises a brewing assembly 52 having a movable brewing piston, which closes a cylindrical brewing chamber. This can be filled in an automated manner with freshly ground coffee powder via two separate grinding mechanisms 53a, 53b for different types of coffee. When the brewing valve 51 is open, hot water can flow from the hot water boiler 10a under pressure of the water pump 34 through the brewing assembly 52. A controllable counter pressure valve 54 is located at the outlet of the brewing assembly 52, via which the flow speed of the freshly brewed coffee beverage can be regulated. From there, the freshly brewed coffee flows to the outlet head 45 of the coffee machine.

Steam for heating and possibly foaming milk is provided via the hot water boiler 10b. A steam line 61, which leads to a steam lance 62, can be released via a valve block 60 having two valves 60a, 60b connected in parallel. Air for foaming the milk can be added to the steam during the dispensing via an air pump 63 and a check valve 64. Moreover, a temperature sensor 65 can be provided at the steam lance 62, which measures the temperature of the milk heated or foamed by means of steam.

In addition, a pressure relief valve 66, a manometer 67, and a temperature sensor 68 are located at the steam outlet of the hot water boiler 10b. The temperature in the interior of the hot water boiler 10b can be monitored via temperature sensors 69 and can be set by corresponding activation of the heater 14.

A significant reduction of the heater waste heat is achieved by the vacuum insulation according to the invention of the hot water boilers 10a, 10b, so that the device can be constructed very compactly without thermal problems occurring in this case. In addition, the vacuum insulation enables hot water to be kept ready at higher storage temperatures, so that a larger water volume is available by admixing cold water during the dispensing. The hot water boiler 10a can therefore either be embodied more compactly or a larger amount of hot beverages can be prepared before hot water has to be reheated again.

The vacuum in the double-walled area of the vacuum insulation is typically less than one millibar, preferably even less than one microbar, and more preferably even less than 0.1 μbar. Additionally, to maintain the long-term stability of the vacuum, a so-called getter material can be introduced into the vacuum in order to absorb gases in the event of minimal leaks and upon outgassing of materials. A getter or getter material is a chemically reactive material which is used to maintain a vacuum for as long as possible. Gas molecules form a chemical compound (oxidation) with the atoms of the getter material on the surface of a getter, or the gas molecules are fixed by sorption. In this way, gas molecules are “captured”. Metals such as barium, aluminum, or magnesium alloys are suitable as the getter, which can possibly be heated after the pumping out in order to vaporize the getter metal.

In addition, reflective films can be introduced into the evacuated gap space 12, 22, which further reduce the waste heat of the hot water boilers 10, 10′.

The vacuum insulation can, as already explained, be part of the hot water boiler and can be mechanically connected thereto or can form a unit or the vacuum insulation can be embodied as a separate component and the hot water boiler can be enclosed therein.

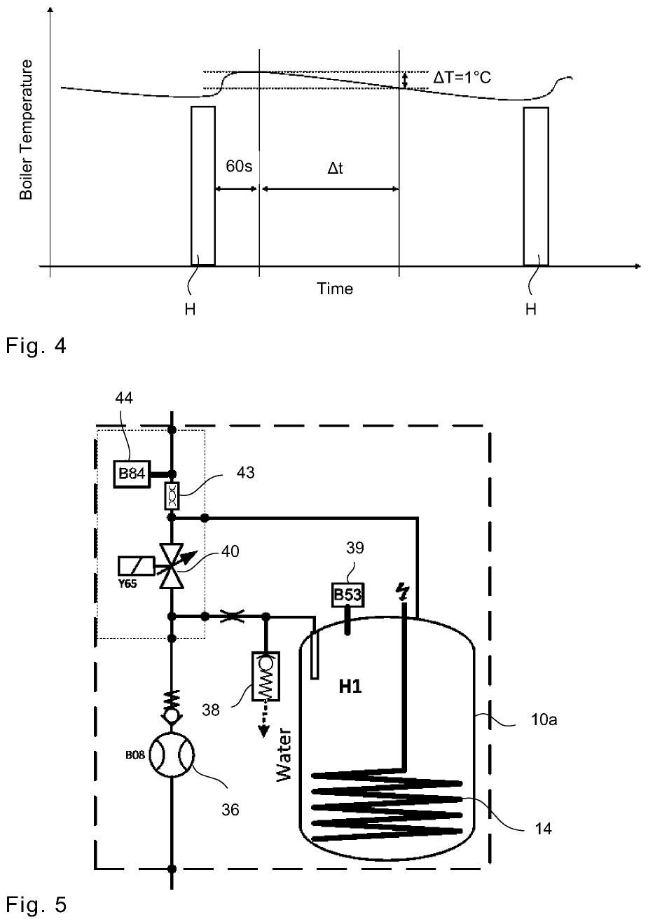

The detection of a cooling curve, which can be used to judge the quality of the vacuum insulation, is illustrated in the diagram shown in FIG. 4, which shows the time curve of the hot water temperature inside the hot water boiler.

For this purpose, an additional software function, which determines the insulation quality on the basis of the cooling curve of the hot water boiler 10, 10′, which can be measured with the aid of the temperature sensor 39, 69, is implemented by means of a controller, which can also be used at the same time for activating the heater 14 and regulating the hot water temperature in the hot water boiler 10, 10′. The vacuum insulation can be checked as a result. If excessively fast cooling is established, it can be inferred that the vacuum of the vacuum insulation is damaged and a corresponding error message can be generated to exchange or repair the vacuum insulation. This information can be queried both on the device itself and also via remote maintenance.

In FIG. 4, the temperature curve measured by the temperature sensor 39 or 69 of the hot water boiler 10a or 10b is plotted over the time t. After switching off the heater, the temperature slowly sinks to a lower regulating threshold. If this is reached, the heater 14 is switched on for a heating period H. The temperature therefore rises again to an upper regulating threshold or to the target temperature in the boiler. A specified time span of 60 seconds here is now waited out until the heater 14 has emitted all of the heating energy to the hot water. The time span Δt is now measured, within which the temperature has sunk by a specified temperature difference ΔT of 1° C. in the exemplary embodiment. This cooling time is a measure for how good the insulation property of the vacuum insulation is. If the 1° cooling time sinks below a minimum value for intact vacuum insulation, an error message is thus generated and it is reported via a data connection to a monitoring center that the vacuum insulation of the boiler 10a or 10b is suspected to be defective and has to be checked. The vacuum insulation can thus be assessed in a simple manner and it can be established whether there is a defect of the vacuum. Of course, for example the time span between two heating periods H can also be detected as the cooling time, thus the time until the temperature has sunk to the lower regulating threshold and the heater 14 is activated again.

1. A hot beverage preparation device, comprising:
at least one hot water boiler (10, 10a, 10b) for heating and storing hot water and/or hot steam for preparing hot beverages, the at least one hot water boiler (10, 10a, 10b) has a cold water inlet, a storage vessel (11, 11′) having a heater (14), and a hot water and/or steam outlet; and
the storage vessel (11, 11′) is at least partially provided or surrounded with a vacuum insulation (12, 22).

2. The hot beverage preparation device as claimed in claim 1, wherein an outer wall (11a, 11b) of the storage vessel includes a double-walled area at least in some regions for the vacuum insulation and the double-walled area of the outer wall encloses an evacuated space (12).

3. The hot beverage preparation device as claimed in claim 2, wherein the storage vessel (20) which includes the double-walled area at least in some regions has a non-vacuum-insulated cover (13, 23), through which at least one of electrical or hydraulic connections (14a, 14b, 15, 16, 17) are led.

4. The hot beverage preparation device as claimed in claim 1, wherein the storage vessel (11′) is received in an external envelope (20) that has a double-walled area at least in some regions, the double-walled area (21a, 21b) of which encloses an evacuated space (22), for the vacuum insulation.

5. The hot beverage preparation device as claimed in claim 4, wherein the external envelope which includes the double-walled area at least in some regions has a non-vacuum-insulated cover (13, 23), through which at least one of electrical or hydraulic connections (14a, 14b, 15, 16, 17) are led.

6. The hot beverage preparation device as claimed in claim 1, wherein the storage vessel (11, 11′) is a pressure vessel, in which the hot water is stored in operation at a temperature of greater than 100° C. and the hot water outlet is connected to a metering valve (40) for adding cold water in a metered manner, in order to admix cold water to the hot water during dispensing, so that mixed water having a temperature of less than 100° C. is dispensed for the beverage preparation.

7. The hot beverage preparation device as claimed in claim 6, wherein the storage vessel (11, 11′) is configured to store hot water in operation at a temperature of greater than 110° C.

8. The hot beverage preparation device as claimed in claim 6, wherein the metering valve (40) for adding cold water comprises a controllable valve, and the hot beverage preparation device has a temperature sensor (44) for determining a mixed water temperature and a control device for regulating the mixed water temperature by activating the metering valve (40).

9. The hot beverage preparation device as claimed in claim 8, further comprising a static mixer arranged between the metering valve (40) and the temperature sensor (44) for mixing the cold and hot water flows.

10. The hot beverage preparation device as claimed in claim 1, wherein the heater (14) comprises a heating coil arranged inside the storage vessel (11, 11′).

11. The hot beverage preparation device as claimed in claim 10, wherein the heating coil extends inside a coiled heating tube (14).

12. The hot beverage preparation device as claimed in claim 11, wherein the coiled heating tube (14) is filled with magnesium oxide powder for the electrical insulation of the heating coil.

13. The hot beverage preparation device as claimed in claim 1, wherein the at least one hot water boiler comprises a first hot water boiler (10a) provided for hot water production and a second hot water boiler (10b) provided for steam production, and the first and second hot water boilers are both provided or surrounded with the vacuum insulation (12, 22).

14. The hot beverage preparation device as claimed in claim 2, further comprising a getter material introduced into the evacuated space (12, 22).

15. The hot beverage preparation device as claimed in claim 2, further comprising a reflective film introduced into the evacuated space (12, 22).

16. The hot beverage preparation device as claimed in claim, 1, further comprising a controller configured with programming, which is connected to a temperature sensor (39, 69) arranged inside the at least one hot water boiler (10, 10′, 10a, 10b) for at least one of monitoring or regulating the hot water temperature or steam temperature, and the controller is configured to detect a cooling time after the heater (14) is switched off and to generate an error message, which indicates a defective vacuum insulation, upon falling below a threshold value.
